(19) United States
(12) Patent Application Publication
(10) Pub. No.: US 2025/0119551 A1
(43) Pub. Date: Apr. 10, 2025

(54) MMVD (MERGED MOTION VECTOR DIFFERENCE) USING DEPTH MAP AND/OR MOTION MAP

(71) Applicant: InterDigital CE Patent Holdings, SAS, Paris (FR)

(72) Inventors: Saurabh Puri, Saint-Lazare (CA); Tangi Poirier, Thorigné-Fouillard (FR); Karam Naser, Mouazé (FR); Gaëlle Martin-Cocher, Toronto (CA)

(73) Assignee: InterDigital CE Patent Holdings, SAS, Paris (FR)

(21) Appl. No.: 18/721,803

(22) PCT Filed: Dec. 21, 2022
(86) PCT No.: PCT/EP2022/087197

§ 371 Date: Jun. 19, 2024

(30) Foreign Application Priority Data
Dec. 21, 2021 (EP) 21306884.4

(51) Int. Cl. H04N 19/139; G06T 7/20; G06T 7/50; H04N 19/176

(52) U.S. Cl. CPC H04N 19/139; G06T 7/20; G06T 7/50; H04N 19/176

(57) ABSTRACT

Systems and methods are disclosed for performing encoding and/or decoding in merged motion vector difference (MMVD) mode using depth and/or motion information. MMVD tables (e.g., MMVD distance and/or direction sets) may be adaptively (e.g., dynamically) generated for blocks based on input motion and/or input depth information. MMVD distance and/or direction sets may accelerate coding, reduce signaling, and/or improve compression. Depth and/or motion information may be used, for example, to adaptively restrict a search for MMVD candidates, change (e.g., reduce, reorder, shift, replace) MMVD distance and/or direction tables. MMVD distance and/or direction sets may be determined from motion characteristics, such as depth maps, motion maps, and/or motion vector predictors (MVPs) (e.g., base MVP, average size of MVPs), average motion of a block, etc.

### CROSS-REFERENCE TO RELATED APPLICATIONS

This application claims the benefit of EP patent application 21306884.4 filed Dec. 21, 2021, the contents of which are hereby incorporated herein by reference in their entirety.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are disclosed for performing encoding and/or decoding in merged motion vector difference (MMVD) mode. A video encoding/decoding device may obtain a motion information refinement table. The motion information refinement table may be, for example, a merged motion vector difference (MMVD) distance table or a MMVD direction table.

The video encoding/decoding device may modify the motion information refinement table based on information associated with a current block. The information associated with the current block may be, for example, one or more of Motion Vector Predictors (MVP), motion information, or depth information. An MVP associated with a video block may indicate a motion associated with an adjacent block of the video block. The motion information associated with the video block may indicate a motion intensity associated with the video block and may comprise or may be derived from a motion map of the video block. The depth information associated with the video block may indicate a distance associated with the video block from a reference point (e.g., a distance of an object from a camera) and may comprise or may be derived from a depth map of the video block.

The motion information refinement table may be a MMVD distance table. The video encoding/decoding device may modify the MMVD distance table by re-ordering the entries in MMVD distance table. The video encoding/decoding device may re-order entries in the MMVD distance table to prioritize likely-used entries in the table.

The encoding/decoding device may determine the manner in which to re-order the MMVD distance table by, for example, determining a depth motion activity index for the current block. The encoding/decoding device may determine the depth motion activity index based at least on one or more of Motion Vector Predictors (MVP), motion information, or depth information. If the information associated with the current block comprises MVPs, the encoding/decoding device may determine an average of the MVPs and determine the depth motion activity index based on at least the average of the MVPs. If the information associated with the current block comprises motion information, the encoding/decoding device may determine a motion activity index based on the motion information and may determine the depth motion activity index based additionally on at least the motion activity index. If the information associated with the current block additionally comprises depth information, the encoding/decoding device may be configured to determine a distance associated with the current block based on at least the depth information and may determine the depth motion activity index based additionally on at least the motion activity index.

If the depth motion activity index is larger than a threshold, the encoding/decoding device may re-order the MMVD distance table in a first manner. If the depth motion activity index is smaller than the threshold, the encoding/decoding device may re-order the MMVD distance table in a second manner. The modified MMVD distance table may be referred to as a modified motion information refinement table.

The motion information refinement table may be a merged motion vector difference (MMVD) direction table and the information associated with the current block may comprise motion information. The encoding/decoding device may generate an average motion of the current block based on motion vectors comprised in the motion information. If the average motion of the block is greater than a value associated with a motion vector predictor (MVP), the encoding/device may determine to modify the MMVD direction table in a first manner. If the average motion of the block is less than the value associated with a motion vector predictor (MVP), the encoding/decoding device may determine to modify the MMVD direction table in a second manner. The modified MMVD direction table may be referred to as a modified motion information refinement table.

The video encoding/decoding device may refine a merge candidate motion vector (MV) associated with the current block based on the modified values in the modified motion information refinement table.

The video encoding/decoding device may encode or decode the current block based on the refined merge candidate MV. In an example wherein the modified motion information refinement table is a modified MMVD direction table, the modified MMVD direction table may comprise a direction index. The encoding/decoding device may send the direction index using truncated unary coding.

Systems, methods, and instrumentalities are disclosed for performing encoding and/or decoding in merged motion vector difference (MMVD) mode using depth and/or motion information. MMVD tables (e.g., MMVD distance and/or direction sets) may be adaptively (e.g., dynamically) generated (e.g., customized) for blocks based on input motion and/or input depth information. Depth and/or motion information may be used, for example, to adaptively restrict a search for MMVD candidates, change (e.g., reduce, reorder, shift, replace) MMVD distance and/or direction tables, select and/or signal a shift factor for a shifted MMVD set or an index for a replaced (e.g., new) MMVD set, and/or to reorder a merge candidate list. MMVD distance and/or direction sets may be determined from motion information (e.g., characteristics), such as depth maps, motion maps, and/or motion vector predictors (MVPs) (e.g., base MVP, average size of MVPs, variance between MVPs), etc. Depth and/or motion information may include derived characteristics, such as an average size of MVPs in a merge candidate list, a motion activity index of a current block, a distance of a current block from a camera, etc.

Dynamic MMVD distance and/or direction sets may (e.g., be used to) accelerate encoding time and/or increase coding gain, for example, by reducing signaling overhead. A re-ordered merge candidate list may be deduced from depth and/or motion data, which may provide coding gains.

A modified MMVD distance table may be determined, for example, based on a depth map, a motion map, and/or motion vector predictors (MVPs). A modified MMVD distance table may be, for example, a reduced or reordered MMVD distance table which may increase coding gains.

A modified MMVD direction table may be determined, for example, based on motion information. A modified MMVD direction table may (e.g., be used to) accelerate encoding. A modified MMVD direction table may be, for example, a reduced or reordered MMVD direction table. A direction index may be coded using truncated unary coding (e.g., instead of fixed length coding).

MMVD distances may be adaptively (e.g., dynamically) shifted at block (e.g., coding unit (CU)) level. MMVD distances may be adaptively shifted, for example, based on depth map, motion map, and/or MVPs. An MMVD shift factor may be signaled, for example, at slice level. An MMVD shift factor may be signaled, for example, based on depth and/or motion.

MVPs may be adaptively reordered in a merge candidate list (e.g., based on motion information), for example, to improve coding efficiency.

A device may obtain at least one of, e.g., both of, an MMVD distance table and/or an MMVD direction table based on at least one of an input depth information or an input motion information associated with a current block. The device may reconstruct the current block based on at least one of, e.g., both of, the MMVD distance table and/or the MMVD direction table. The values in the MMVD distance table associated with the current block may be determined based on the input depth information associated with the current block. The values in the MMVD direction table associated with the current block may be determined based on the input motion information associated with the current block. The values in the MMVD distance table associated with the current block may be ordered based on at least one of the input depth information or the input motion information associated with the current block. The values in the MMVD direction table associated with the current block may be ordered based on at least one of the input depth information or the input motion information associated with the current block.

A device may determine at least one of, e.g., both of, an MMVD distance table and/or an MMVD direction table based on at least one of an input depth information or an input motion information associated with a current block. The device may encode the current block based on at least one of, e.g., both of, the MMVD distance table and/or the MMVD direction table. The device may determine at least one of an MMVD distance index or an MMVD direction index based on at least one of the MMVD distance table or the MMVD direction table. The values in the MMVD distance table associated with the current block may be determined based on the input depth information associated with the current block. The values in the MMVD direction table associated with the current block may be determined based on the input motion information associated with the current block. The values in the MMVD distance table associated with the current block may be ordered based on at least one of the input depth information or the input motion information associated with the current block. The values in the MMVD direction table associated with the current block may be ordered based on at least one of the input depth information or the input motion information associated with the current block.

In examples (e.g., with motion information available to encoder and decoder), a plurality of MVPs in a merge candidate list associated with a current block may be ordered based on input motion information associated with the current block. In examples (e.g., with motion information available to encoder only), a merge candidate index associated with a current block may be obtained. A base motion vector (MV) for MMVD may be determined (e.g., based on the merge candidate index). A current block may be reconstructed based on the determined base MV and an associated distance and direction table.

Systems, methods, and instrumentalities described herein may involve a decoder. In some examples, the systems, methods, and instrumentalities described herein may involve an encoder. In some examples, the systems, methods, and instrumentalities described herein may involve a signal (e.g., from an encoder and/or received by a decoder). A computer-readable medium may include instructions for causing one or more processors to perform methods described herein. A computer program product may include instructions which, when the program is executed by one or more processors, may cause the one or more processors to carry out the methods described herein. The device may include an indication of at least one of the MMVD distance index or the MMVD direction index in a bitstream.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example video encoder.

FIG. 3 illustrates an example video decoder.

FIG. 4 illustrates an example of a system in which various aspects and examples may be implemented.

FIG. 5 illustrates an example of a texture frame of a video game with a corresponding depth map, horizontal motion data and vertical motion data extracted (e.g., directly) from a game engine rendering a game scene.

FIG. 6 illustrates an example architecture of a cloud gaming system with a game engine running on a cloud server.

FIG. 7 illustrates an example of MMVD search point directions.

FIG. 8 illustrates an example of a game scene with foreground and background.

FIG. 9 illustrates an example of determining a MMVD distance table based on input depth, motion, MVPs, and block size.

FIG. 10 illustrates an example of determining a MMVD direction table based on a motion map.

FIG. 11 illustrates an example of employing depth or motion information for encoder acceleration.

FIG. 12 illustrates an example of determining MMVD set derivation at the encoder side and the decoder side based on depth and/or motion map.

FIG. 13 illustrates an example of re-ordered MMVD set derivation (e.g., at the encoder side and the decoder side) based on a depth map and/or a motion map.

FIG. 14 illustrates an example of determining an MMVD set after applying a shift factor s on the encoder side and the decoder side.

FIG. 15 illustrates an example of determining a MMVD set based on depth and/or motion information.

FIG. 16 illustrates an example of adaptively re-ordering MVPs in merge candidates (e.g., if/when motion data is available on the encoder side and the decoder side).

FIG. 17 illustrates an example of determining a merge candidate index to indicate an (e.g., the best) MV to be used as a base MV for MMVD refinement.

### DETAILED DESCRIPTION

A more detailed understanding may be had from the following description, given by way of example in conjunction with the accompanying drawings.

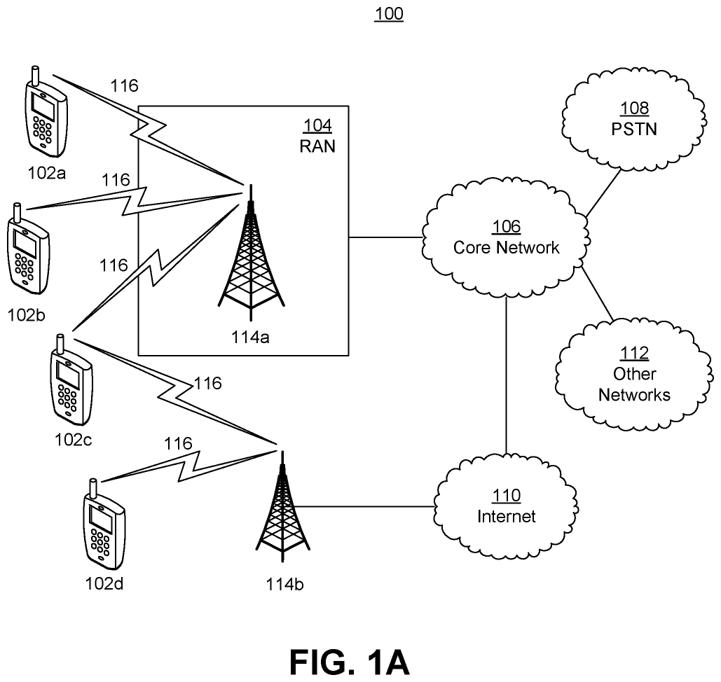

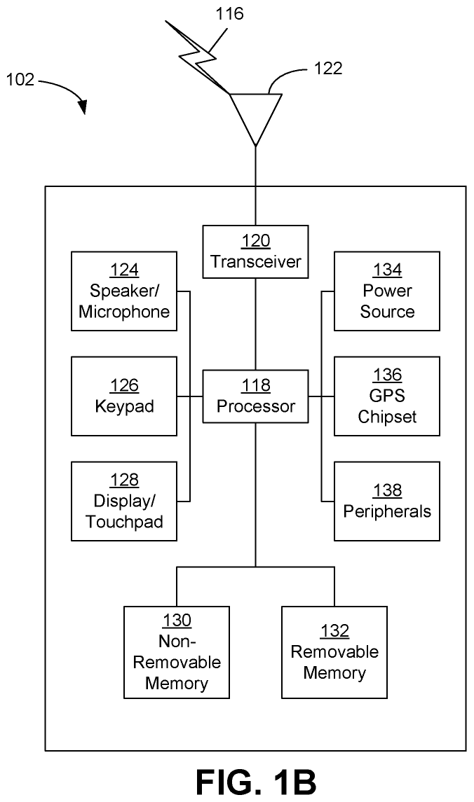

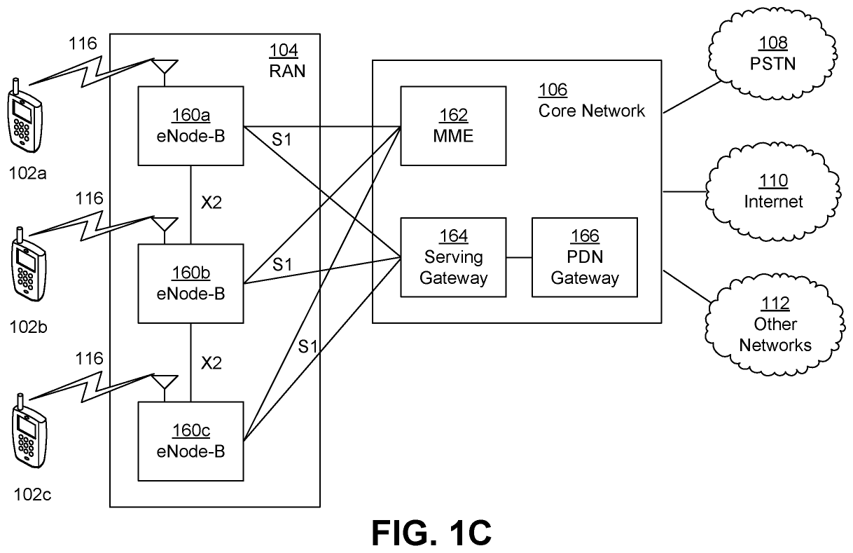

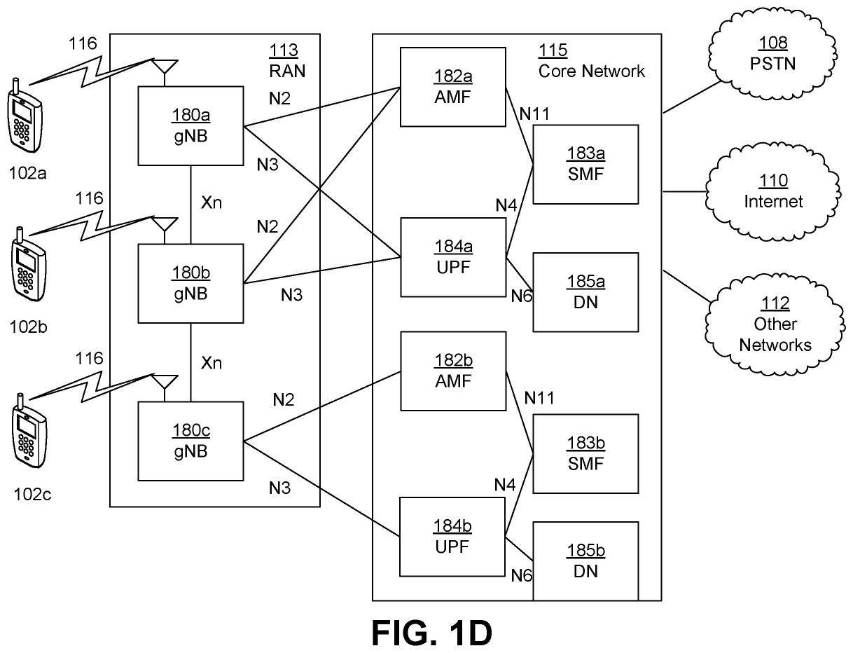

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example, in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

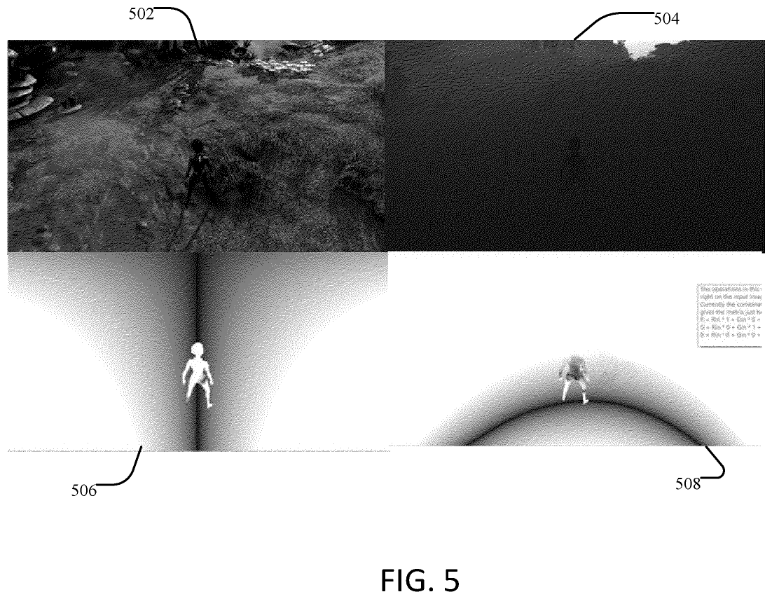

The aspects described and contemplated in this application may be implemented in many different forms. FIGS. 5-17 described herein may provide some examples, but other examples are contemplated. The discussion of FIGS. 5-17 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

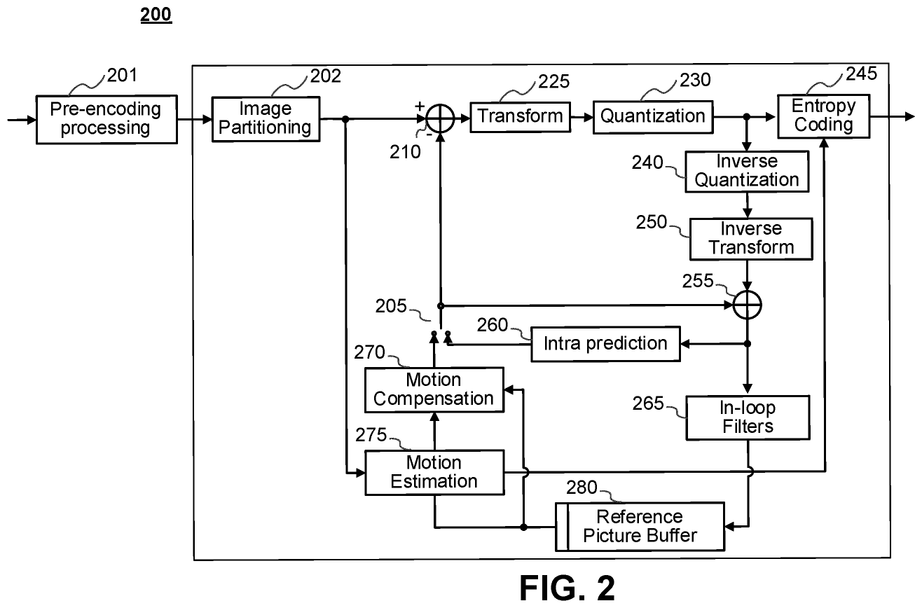

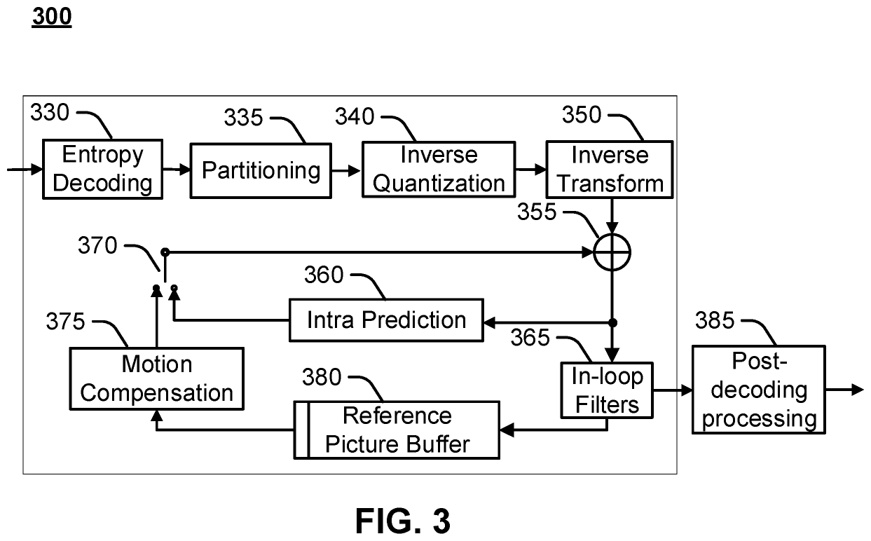

Various implementations and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described in the present application, such as numbers of bits, bit depth, weights, number of search directions, signaling, flags, distance table set, etc. These and other specific values are for the purpose of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing and attached to the bitstream.

In the encoder 200, a picture may be encoded by the encoder elements as described below. The picture to be encoded may be partitioned (202) and processed in units of, for example, coding units (CUs). Each unit may be encoded using, for example, either an intra or inter mode. When a unit is encoded in an intra mode, it may perform intra prediction (260). In an inter mode, motion estimation (275) and compensation (270) may be performed. The encoder may decide (205) which one of the intra mode or inter mode to use for encoding the unit and may indicate the intra/inter decision by, for example, a prediction mode flag. Prediction residuals may be calculated, for example, by subtracting (210) the predicted block from the original image block.

The prediction residuals may be transformed (225) and quantized (230). The quantized transform coefficients, as well as motion vectors and other syntax elements (e.g., picture partitioning information), may be entropy coded (245) to output a bitstream. The encoder may skip the transform and apply quantization, e.g., apply quantization directly, to the non-transformed residual signal. The encoder may bypass both transform and quantization, i.e., the residual may be coded, e.g., coded directly, without the application of the transform or quantization processes.

The encoder may decode an encoded block to provide a reference for further predictions. The quantized transform coefficients may be de-quantized (240) and inverse transformed (250) to decode prediction residuals. Combining (255) the decoded prediction residuals and the predicted block, an image block may be reconstructed. In-loop filters (265) may be applied to the reconstructed picture to perform, for example, deblocking/SAO (Sample Adaptive Offset)/ALF (Adaptive Loop Filter) filtering to reduce encoding artifacts. The filtered image may be stored at a reference picture buffer (280).

FIG. 3 is a diagram showing an example of a video decoder. In example decoder 300, a bitstream may be decoded by the decoder elements as described below. Video decoder 300 generally may perform a decoding pass reciprocal to the encoding pass as described in FIG. 2. The encoder 200 also may generally perform video decoding as part of encoding video data.

The input of the decoder may include a video bitstream, which may be generated by video encoder 200. The bitstream may be first entropy decoded (330) to obtain transform coefficients, prediction modes, motion vectors, and other coded information. The picture partition information may indicate how the picture is partitioned. The decoder may therefore divide (335) the picture according to the decoded picture partitioning information. The transform coefficients may be de-quantized (340) and inverse transformed (350) to decode the prediction residuals. Combining (355) the decoded prediction residuals and the predicted block, an image block may be reconstructed. The predicted block may be obtained (370) from intra prediction (360) or motion-compensated prediction (i.e., inter prediction) (375). In-loop filters (365) may be applied to the reconstructed image. The filtered image may be stored at a reference picture buffer (380). The contents of the reference picture buffer 380 on the decoder 300 side may be identical to the contents of the reference picture buffer 280 on the encoder 200 side for a (e.g., the same) picture.

The decoded picture may further go through post-decoding processing (385) such as, for example, an inverse color transform (e.g., conversion from YCbCr 4:2:0 to RGB 4:4:4) or an inverse remapping performing the inverse of the remapping process performed in the pre-encoding processing (201). The post-decoding processing may use metadata derived in the pre-encoding processing and signaled in the bitstream. The decoded images (e.g., after application of the in-loop filters (365) and/or after post-decoding processing (385), if post-decoding processing is used) may be sent to a display device for rendering to a user.

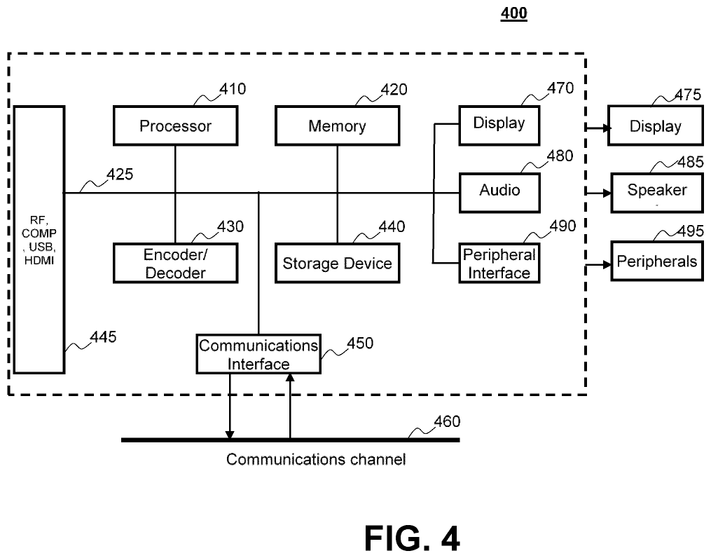

FIG. 4 is a diagram showing an example of a system in which various aspects and examples described herein may be implemented. System 400 may be embodied as a device including the various components described below and is configured to perform one or more of the aspects described in this document. Examples of such devices may include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 may be distributed across multiple ICs and/or discrete components. In various examples, the system 400 is communicatively coupled to one or more other systems, or other electronic devices, via, for example, a communications bus or through dedicated input and/or output ports. In various examples, the system 400 may be configured to implement one or more of the aspects described in this document.

The system 400 may include at least one processor 410 configured to execute instructions loaded therein for implementing, for example, the various aspects described in this document. Processor 410 may include embedded memory, input output interface, and various other circuitries as known in the art. The system 400 may include at least one memory 420 (e.g., a volatile memory device, and/or a non-volatile memory device). System 400 may include a storage device 440, which may include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 may include an internal storage device, an attached storage device (including detachable and non-detachable storage devices), and/or a network accessible storage device, as non-limiting examples.

The system 400 may include an encoder/decoder module 430 configured, for example, to process data to provide an encoded video or decoded video, and the encoder/decoder module 430 may include its own processor and memory. The encoder/decoder module 430 may represent module(s) that may be included in a device to perform the encoding and/or decoding functions. As is known, a device may include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 may store one or more of various items during the performance of the processes described in this document. Such stored items may include, but are not limited to, the input video, the decoded video or portions of the decoded video, the bitstream, matrices, variables, and intermediate or final results from the processing of equations, formulas, operations, and operational logic.

Memory inside of the processor 410 and/or the encoder/decoder module 430 may be used to store instructions and to provide working memory for processing that is needed during encoding or decoding. In examples, however, a memory external to the processing device (for example, the processing device may be either the processor 410 or the encoder/decoder module 430) may be used for one or more of these functions. The external memory may be the memory 420 and/or the storage device 440, for example, a dynamic volatile memory and/or a non-volatile flash memory. In several examples, an external non-volatile flash memory may be used to store the operating system of, for example, a television. In at least one example, a fast external dynamic volatile memory such as a RAM may be used as working memory for video encoding and decoding operations.

The input to the elements of system 400 may be provided through various input devices as indicated in block 445. Such input devices may include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, may include composite video.

The input devices of block 445 may have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples may include one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, downconverting the received signal to a lower frequency (for example, an intermediate frequency or a near-baseband frequency) or to baseband. In one set-top box example, the RF portion and its associated input processing element may receive an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements may include inserting elements in between existing elements, such as, for example, inserting amplifiers and an analog-to-digital converter. In various examples, the RF portion may include an antenna.

The USB and/or HDMI terminals may include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream may be provided to various processing elements, including, for example, processor 410, and encoder/decoder 430 operating in combination with the memory and storage elements to process the data stream as necessary for presentation on an output device.

Various elements of system 400 may be provided within an integrated housing. Within the integrated housing, the various elements may be interconnected and may transmit data therebetween using suitable connection arrangement 425 such as, for example, an internal bus as known in the art, including the Inter-IC (12C) bus, wiring, and printed circuit boards.

The system 400 may include communication interface 450 that enables communication with other devices via communication channel 460. The communication interface 450 may include, but is not limited to, a transceiver configured to transmit and to receive data over communication channel 460. The communication interface 450 may include, but is not limited to, a modem or network card and the communication channel 460 may be implemented, for example, within a wired and/or a wireless medium.

Data may be streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples may be received over the communications channel 460 and the communications interface 450 which are adapted for Wi-Fi communications. The communications channel 460 of these examples may be typically connected to an access point or router that may provide access to external networks including the Internet for allowing streaming applications and other over-the-top communications. Other examples may provide streamed data to the system 400 using a set-top box that may deliver the data over the HDMI connection of the input block 445. Still other examples may provide streamed data to the system 400 using the RF connection of the input block 445. As indicated herein, various examples may provide data in a non-streaming manner. Additionally, various examples may use wireless networks other than Wi-Fi, for example a cellular network or a Bluetooth® network.

The system 400 may provide an output signal to various output devices, including a display 475, speakers 485, and other peripheral devices 495. The display 475 of various examples may include one or more of, for example, a touchscreen display, an organic light-emitting diode (OLED) display, a curved display, and/or a foldable display. The display 475 may be for a television, a tablet, a laptop, a cell phone (mobile phone), or other device. The display 475 may also be integrated with other components (for example, as in a smart phone), or separate (for example, an external monitor for a laptop). The other peripheral devices 495 may include, in various examples, one or more of a stand-alone digital video disc (or digital versatile disc) (DVD, for both terms), a disk player, a stereo system, and/or a lighting system. Various examples may use one or more peripheral devices 495 that may provide a function based on the output of the system 400. For example, a disk player may perform the function of playing the output of the system 400.

Control signals may be communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. The output devices may be connected to system 400 using the communications channel 460 via the communications interface 450. The display 475 and speakers 485 may be integrated into a single unit with the other components of system 400 in an electronic device such as, for example, a television. In various examples, the display interface 470 may include a display driver, such as, for example, a timing controller (T Con) chip.

The display 475 and speakers 485 may be separate from one or more of the other components, for example, if the RF portion of input 445 may be part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations may involve decoding. “Decoding,” as used in this application, may encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. Such processes also, or alternatively, may include processes performed by a decoder of various implementations described in this application, for example, obtaining at least one of an MMVD distance table or an MMVD direction table based on at least one of an input depth information or an input motion information associated with a current block, reconstructing the current block based on at least one of the MMVD distance table or the MMVD direction table, etc.

“Decoding” may refer to (e.g., only to) entropy decoding, in another example “decoding” may refer to, e.g., only to, differential decoding, and in another example “decoding” may refer to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding,” “encoding” as used in this application may encompass all or part of the processes performed, for example, on an input video sequence in order to produce an encoded bitstream. In various examples, such processes may include one or more of the processes typically performed by an encoder, for example, partitioning, differential encoding, transformation, quantization, and entropy encoding. In various examples, such processes also, or alternatively, may include processes performed by an encoder of various implementations described in this application, for example, determining at least one of an MMVD distance table or an MMVD direction table based on at least one of an input depth information or an input motion information associated with a current block, encoding the current block based on at least one of the MMVD distance table or the MMVD direction table, determining at least one of an MMVD distance index or an MMVD direction index based on at least one of the MMVD distance table or the MMVD direction table, including an indication of at least one of the MMVD distance index or the MMVD direction index in a bitstream, etc.

“Encoding” may refer to, e.g., only to, entropy encoding, in another example “encoding” may refer to, e.g., only to, differential encoding, and in another example “encoding” may refer to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, coding syntax such as ph_mmvd_fullpel_only_flag and coding syntax shown in Tables 5 and 6, etc., may present descriptive terms. As such, they may not preclude the use of other syntax element names.

If a figure is presented as a flow diagram, it should be understood that it also provides a block diagram of a corresponding apparatus. Similarly, if a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, a processor, which may refer to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation,” as well any other variations, appearing in various places throughout this application are not necessarily all referring to the same example.

Additionally, this application may refer to “determining” various pieces of information. Determining the information may include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing,” intended to be a broad term. Receiving the information may include one or more of, for example, accessing the information, or retrieving the information (for example, from memory). Further, “receiving” may be typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C,” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As used herein, the word “signal” may refer to, among other things, indicating something to a corresponding decoder. Encoder signals may include, for example, an MMVD distance index and direction index, an MMVD method for the direction index (e.g., using truncated unary code), a shift factor (e.g., at a slice level), an index (e.g., at a slice level) to point to a replacement MMVD distance table, etc. In this way, in an example the same parameter is used at both the encoder side and the decoder side. Thus, for example, an encoder may transmit (explicit signaling) a particular parameter to the decoder so that the decoder can use the same particular parameter. Conversely, if the decoder already has the particular parameter as well as others, then signaling may be used without transmitting (e.g., implicit signaling) to simply allow the decoder to know and select the particular parameter. By avoiding transmission of any actual functions, a bit savings may be realized in various examples. It is to be appreciated that signaling may be accomplished in a variety of ways. For example, one or more syntax elements, flags, and so forth may be used to signal information to a corresponding decoder in various examples. While the preceding relates to the verb form of the word “signal,” the word “signal” can also be used herein as a noun.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples may be described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. Features described herein may be implemented as a method, process, apparatus, medium storing instructions, medium storing data, or signal. For example, features described herein may be implemented by a TV, set-top box, cell phone, tablet, or other electronic device that performs decoding. The TV, set-top box, cell phone, tablet, or other electronic device may display (e.g., using a monitor, screen, or other type of display) a resulting image (e.g., an image from residual reconstruction of the video bitstream). The TV, set-top box, cell phone, tablet, or other electronic device may receive a signal including an encoded image and perform decoding.

Merge mode with motion vector difference using depth and/or motion maps may be implemented, for example, in the context of video coding. Merge mode with motion vector difference using depth and/or motion maps may utilize depth and/or motion information, for example, along with texture information (e.g., luma and/or chroma information). Merge mode with motion vector difference using depth and/or motion maps may improve compression efficiency, for example, by reducing the bitrate while maintaining quality, and/or by (e.g., equivalently) improving quality while maintaining the bitrate. Depth and/or motion information may be coded for one or more blocks of a picture (e.g., all blocks or some parts of the blocks of a picture). Coded depth and/or motion information may be used (e.g., for merged motion vector difference (MMVD)) to adapt the distance index table, for example, by pruning or re-ordering the distance index table. In some (e.g., alternative) examples, motion information may be used to determine the direction index.

Luma and depth may be jointly coded. For example, a depth map may represent the (e.g., basic) geometry of a captured video scene. A depth map may be available for a (e.g., each) texture picture of video content, for example, as a dense monochrome picture of same resolution as the luma picture.

Merge mode with motion vector difference using depth and/or motion maps may be implemented in video coding. Merge mode with motion vector difference using depth and/or motion maps in a (e.g., specialized) system may be used in various systems such as, for example, a system with cloud gaming servers or a device with a mobile operating system (e.g., iOS) with light detection and ranging (LiDAR). An input texture frame, a correlated depth map, and motion information may be presented to a video codec as side information.

FIG. 5 illustrates an example of a texture frame of a video game with a corresponding depth data (e.g., a depth map), horizontal motion data and vertical motion data extracted (e.g., directly) from a game engine rendering a game scene. FIG. 5 shows examples of a texture frame 502 (top-left), a depth map 504 (top-right), horizontal motion 506 (bottom-left) and vertical motion 508 (bottom-right) extracted from a game engine. In examples, the depth map may be represented by a grey-level image that may indicate the distance (e.g., depth value) between a camera and an actual object (e.g., respective distances of the samples associated with the object from the camera). The depth map may represent the basic geometry (e.g., including discontinuities, depth edges, etc.) of the captured video scene. The depth map may correspond to a texture picture of the video content and may be represented as a dense monochrome picture. The depth map may have the same resolution as, or a different resolution than. the resolution of a luma picture associated with the video content (e.g., the depth map may include one depth value for each sample or one depth value for multiple samples).

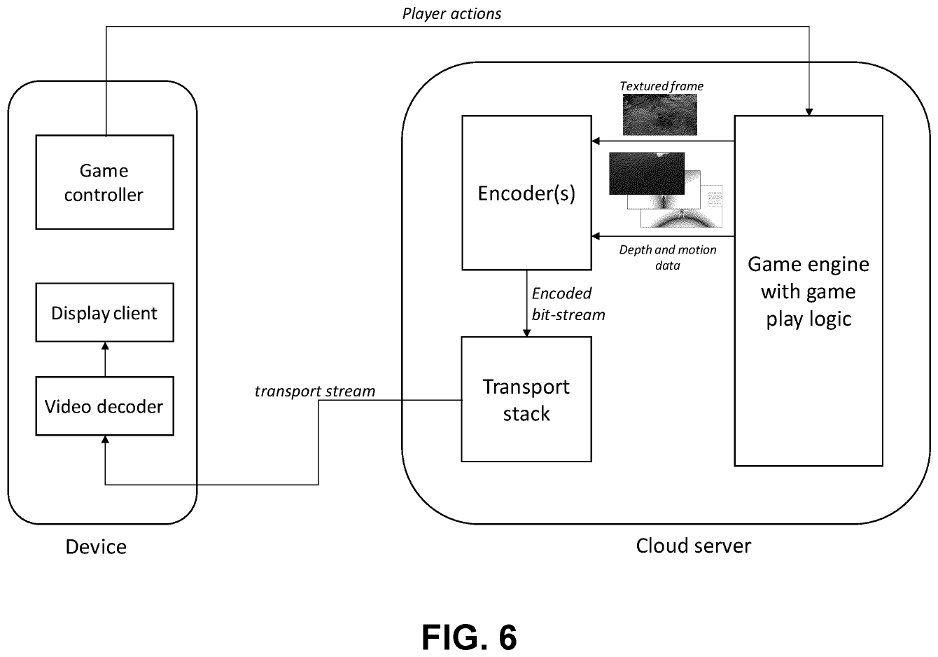

FIG. 6 illustrates an example architecture of a cloud gaming system with a game engine running on a cloud server. The cloud gaming system may render a game scene based on player actions. The rendered game scene may be encoded into a bit-stream using a video encoder. The bit-stream may be encapsulated by a transport protocol and sent as a transport stream to the player's device. The player's device may de-encapsulate and decode the transport stream and present the decoded game scene to the player.

As illustrated by example in FIG. 6, additional information, such as, for example, a depth map, motion information, object ID, occlusion mask, camera parameters, etc., may be taken from a game engine output and made available to the encoder (e.g., as prior information).

Advanced motion vector prediction (AMVP) mode, merge mode, skip mode, etc. may be used in video encoding and/or decoding. Weighted bi-directional prediction may be performed, and an increase in precision of MV to 1/16-pel may be implemented.

Merge mode may be computationally less expensive than (e.g., regular) AMVP mode. Merge mode, skip mode and/or (e.g., regular) AMVP mode may be implemented. An (e.g., a regular) AMVP mode may be used to signal motion information related to a block for a (e.g., each) reference frame list, such as a reference frame index (e.g., refIdx), motion vector predictor index (e.g., mvpIdx), motion vector differential (MVD), adaptive motion vector resolution (AMVR) index, etc.

In some examples (e.g., in merge and/or skip mode), motion information of a current block may be derived from neighboring blocks. Motion information derived from neighboring block(s) may be referred to as motion vector predictors (MVPs). refIdx and MVD may not be signaled. An AMVR index may not be signaled, for example, if MVD is 0. A residual may be coded in merge mode. A residual may not be coded in skip mode (e.g., where the residual may be inferred to be zero).

For example, a list of MVPs may include predictors from neighboring blocks, history-based motion vector predictors (HMVPs), and/or pair-wise predictors.

A merged motion vector difference (MMVD) mode may be implemented. Correction (e.g., small correction) may be allowed around a base MV candidate obtained from a list of MVPs. A correction may be performed (e.g., in a controlled manner), for example, in a horizontal (e.g., left-right) direction or in a vertical (e.g., up-down) direction (e.g., at a set of pre-defined distances from the base MV).

A combined intra-inter prediction (CIIP) mode may be implemented. A CIIP mode may be applied to merge mode. A planar intra-prediction mode may be used to generate an intra-prediction block. Intra prediction and inter prediction information may be combined, for example, using a weighted average.

A geometric partitioning mode (GPM) may be used code a video block (e.g., for an inter-predicted video block). GPM may be used to allow non-rectangular partitions in inter block. A block may be split into multiple (e.g., two) parts, for example, using a diagonal line. Each part of a geometric partition may be (e.g., independently) predicted from a different reference frame. Sample values along a geometric partition edge may be adjusted (e.g., after prediction), for example, using a blending process with adaptive weights.

An MMVD mode may be supported for inter prediction. An MMVD mode may be applied, for example, with (e.g., on top of) a merge mode and/or a skip mode. An AMVP mode may utilize more bits compared to merge mode and/or skip mode. An AMVP mode may signal an MVD per reference picture list. An AMVP mode may represent motion more accurately compared to merge or skip mode. MMVD mode may fall between (e.g., regular) AMVP mode and (e.g., regular) merge/skip modes. MMVD mode may provide a trade-off between the accuracy of motion information and the bit rate.

A base MV candidate may be selected from multiple (e.g., out of the first two) merge candidates from the list. The base motion, which may be referred to as, for example, a merge candidate motion vector, may be refined, for example, using small MVD, which may be represented by a direction and/or a distance. Table 1 shows an example of a distance table. Table 2 shows an example of a direction table. The distance may be coded using truncated unary coding to allow efficient coding of distances that are most used. The direction may be, however, fixed length coded. In addition to the distance index and direction index, a merge candidate flag may be coded to indicate which of the 2 merge candidates is refined.

TABLE 1
Example of an MMVD distance table

| Distance | | | | | | | | |
|---|---|---|---|---|---|---|---|---|
| IDX | 0 | 1 | 2 | 3 | 4 | 5 | 6 | 7 |
| Signaling | 0 | 10 | 110 | 1110 | 11110 | 111110 | 1111110 | 1111111 |
| Offset | 1/4 | 1/2 | 1 | 2 | 4 | 8 | 16 | 32 |
| (in unit | | | | | | | | |
| of luma | | | | | | | | |
| samples) | | | | | | | | |

TABLE 2
Example of an MMVD direction index table

| Direction IDX | 0 | 1 | 2 | 3 |
|---|---|---|---|---|
| Signaling | 00 | 01 | 10 | 11 |
| x-axis | + | − | N/A | N/A |
| y-axis | N/A | N/A | + | − |

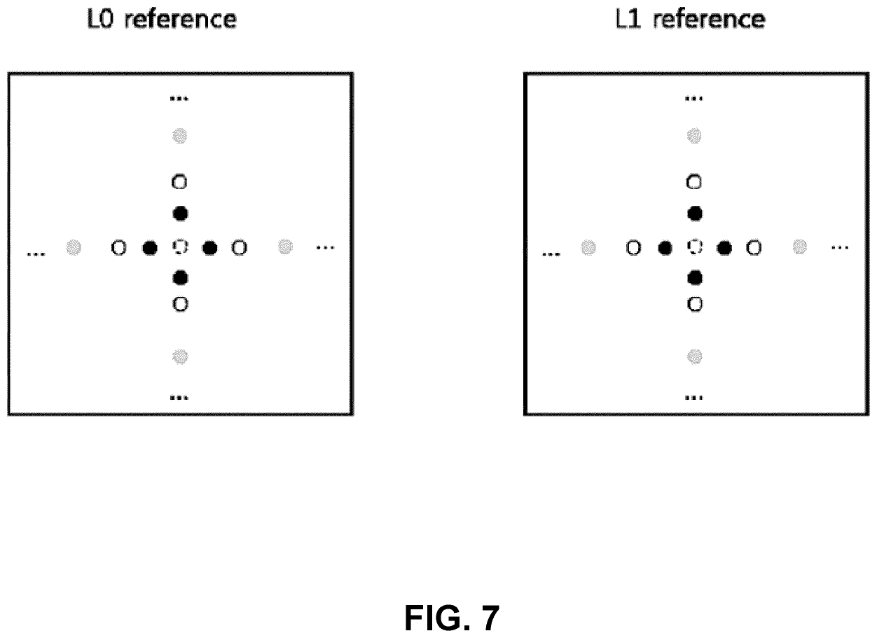

FIG. 7 illustrates an example of MMVD search point directions. In some examples (e.g., as shown in FIG. 7), directions supported may include up, down, left, and right. In some examples, directions supported may include diagonal directions (e.g., diagonal-up, diagonal-down, diagonal-left, and/or diagonal-right). The distance between the pixels may increase moving further from the base MV.

A different distance table may be used for screen content sequences (e.g., if using fractional distances for screen content coding (SCC) is unreasonable). Using an integer distance table may provide gain for SCC sequences.

TABLE 3
Example of MMVD distance tables for different
(e.g., SCC and non-SCC) scene categories

| Scene Category | Distance table |
|---|---|
| Non-SCC | {¼, ½, 1, 2, 4, 8, 16, 32}-pel |
| SCC | {1, 2, 4, 8, 16, 32, 64, 128}-pel |

One or more of the following may be implemented: extension of MMVD into diagonal directions; re-ordering merge candidates and/or re-ordering MMVD refinement table based on template matching; signaling and/or re-ordering MMVD distance table at slice or picture level; use of all or substantially all merge candidates instead first two merge candidates to refine motion; and/or extension of an MMVD tool to affine (e.g., AffineMMVD). The signaling cost of an MMVD index may be reduced. An MMVD may increase the search range.

Depth and/or motion information available prior to encoding and/or decoding (e.g., from a game engine) may be leveraged to improve MMVD. Depth and/or motion information (e.g., as shown by example in FIG. 5) may be used to improve the performance of MMVD mode and/or AffineMMVD mode. Regular MMVD and affine MMVD mode may be referred to herein as MMVD.

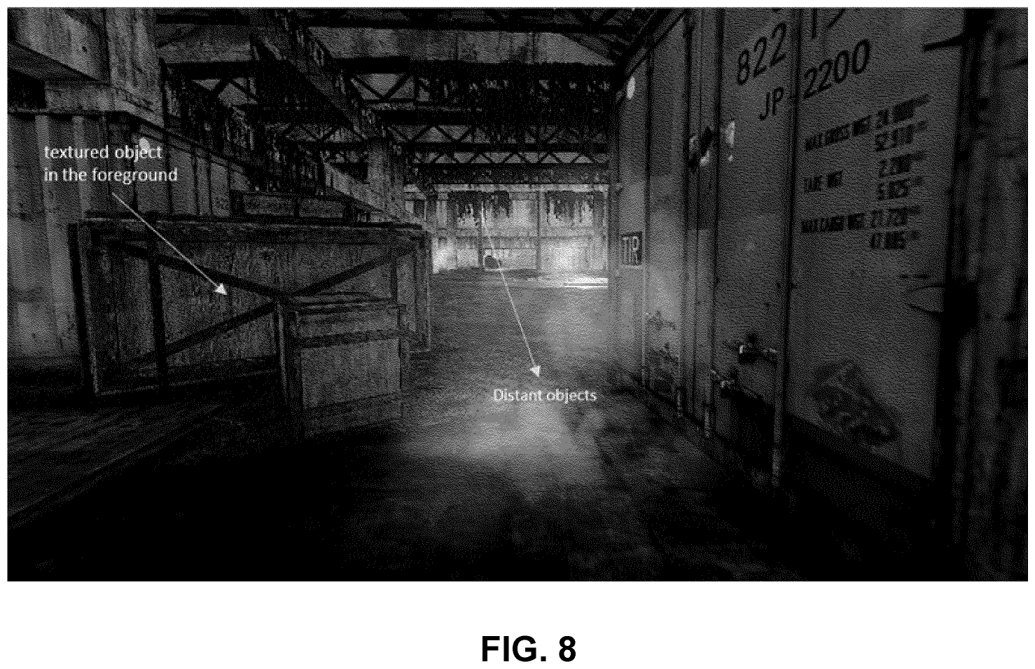

An example gaming scene may include a background scene and one or more foreground objects that may be (e.g., further) classified into moving objects or stationary objects. A background scene may be static. A background scene may include heavy texture (e.g., for rocks, mountains, grass, and/or the like), which may be difficult to encode. FIG. 8 illustrates an example of a game scene with foreground and background.

In some examples, the distance (or depth) of an object in a scene from the camera may be considered as a feature (e.g., to determine the best MMVD mode). Merge mode usage may be higher in frames that have small inter-frame motion. Blocks with small motion may (e.g., generally) favor fractional distances (e.g., compared to blocks with larger motion). Motion parallax refers to observed motion at different distances. For example, objects far from a camera may appear to move less compared to objects close to the camera. Depth may be a useful feature (e.g., to accurately depict motion).

Motion data (e.g., from a game engine) may be used to determine the level of activity between different frames and/or different regions (e.g., a coding unit (CU) or coding tree unit (CTU)) within a given frame. An MMVD distance index may be (e.g., adaptively) selected or chosen, for example, based on the level of activity. A higher level of activity may involve larger distances (e.g., and vice versa). The accuracy of a predictor may be less on an average (e.g., causing MVP and MV to be different) and/or may involve larger refinement of the base motion, for example, in regions with high motion. MVP and MV may be close to each other, for example, in regions with slow or no motion. Finer corrections may be implemented, for example, in regions with slow or no motion.

Information, such as distance from a camera (e.g., represented via a depth map) and/or motion characteristics of an object (e.g., represented via a motion map) may be employed, for example, for video encoding and/or decoding.

In an example of an encoder improvement, depth (e.g., or distance of a block from a camera) and/or motion characteristics may help reduce a search for best MMVD refinement, e.g., by reducing the number of rate distortion (RD) checks.

In an example of a coding gain improvement, depth and/or motion characteristics may help adaptively re-order an MMVD refinement table to reduce signaling cost, e.g., by testing and signaling most probable MMVD first. Depth and/or motion may (e.g., additionally and/or alternatively) be used to deduce a MMVD distance table, e.g., a new MMVD distance table, more suitable for a given block or slice. Depth and/or motion may (e.g., additionally and/or alternatively) help deduce the (e.g., best) base MV predictor and/or re-order the merge candidate list, which may achieve (e.g., further) coding gains.

Encoding and/or decoding may be performed in merged motion vector difference (MMVD) mode using depth and/or motion information. Motion information may comprise or be derived from a motion map for a video block. Depth information may comprise or be derived from a depth map for a video block. MMVD tables (e.g., MMVD distance and/or direction sets) may be adaptively (e.g., dynamically) generated (e.g., customized) for blocks based on input motion and/or input depth information. This may accelerate encoding time and/or increase coding gain, for example, by reducing signaling overhead. A re-ordered merge candidate list may be deduced from depth and/or motion data, which may provide coding gains.

An MMVD distance table, which may be referred to, for example, as a motion information refinement table, may be determined, for example, based on a depth map, a motion map, and/or motion vector predictors (MVPs), each of which may be referred to, for example, as information associated with the current block. An MMVD distance table may (e.g., be used to) accelerate encoding and/or reduce signaling. An MMVD distance table may be, for example, a reduced or reordered MMVD distance table, e.g., a modified motion information refinement table.

An MMVD direction table, which may be referred to, for example, as a motion information refinement table, may be determined, for example, based on motion information. An MMVD direction table may (e.g., be used to) reduce signaling cost. An MMVD direction table may be, for example, a reduced or reordered MMVD direction table, e.g., a modified motion information refinement table. A direction index may be coded using truncated unary coding (e.g., instead of fixed length coding).

MMVD distances may be adaptively (e.g., dynamically) shifted at block (e.g., coding unit (CU)) level, for example, to save bitrate. MMVD distances may be adaptively shifted, for example, based on depth map, motion map, and/or MVPs. An MMVD shift factor may be signaled, for example, at slice level. An MMVD shift factor may be signaled, for example, based on depth and/or motion.

MVPs may be adaptively reordered in a merge candidate list, for example, to improve coding efficiency.

A video encoding/decoding device may modify a motion information refinement table (e.g., a MMVD distance table and/or MMVD direction table) based on information associated with a current block. For example, the video encoding/decoding device may modify the motion information refinement table based on one or more of Motion Vector Predictors (MVP), motion information (e.g., motion map), or depth information (e.g., depth map). The video encoding/decoding device may refine a merge candidate motion vector (MV) of the current block based on the modified motion information refinement table. The video encoding/decoding device may encode or decode the current block based on the refined merge candidate MV.

A video processing device may obtain at least one of an MMVD distance table or an MMVD direction table based on at least one of an input depth information or an input motion information associated with a current block. The device may reconstruct the current block based on at least one of the MMVD distance table or the MMVD direction table. The values in the MMVD distance table associated with the current block may be determined based on the input depth information associated with the current block. The values in the MMVD direction table associated with the current block may be determined based on the input motion information associated with the current block. The values in the MMVD distance table associated with the current block may be ordered based on at least one of the input depth information or the input motion information associated with the current block. The values in the MMVD direction table associated with the current block may be ordered based on at least one of the input depth information or the input motion information associated with the current block.

A device may determine at least one of an MMVD distance table or an MMVD direction table based on at least one of an input depth information or an input motion information associated with a current block. The device may encode the current block based on at least one of the MMVD distance table or the MMVD direction table. The device may determine at least one of an MMVD distance index or an MMVD direction index based on at least one of the MMVD distance table or the MMVD direction table. The values in the MMVD distance table associated with the current block may be determined based on the input depth information associated with the current block. The values in the MMVD direction table associated with the current block may be determined based on the input motion information associated with the current block. The values in the MMVD distance table associated with the current block may be ordered based on at least one of the input depth information or the input motion information associated with the current block. The values in the MMVD direction table associated with the current block may be ordered based on at least one of the input depth information or the input motion information associated with the current block.

MMVD mode may perform a controlled motion estimation, for example, where multiple (e.g., a few) pre-defined positions around a predictor (e.g., a base motion vector) may be searched (e.g., as a refinement step). For example, an RD search for a best candidate may be performed on 32 refinement positions.

In an example of MMVD, the search for a (e.g., the best) MMVD candidate may be focused, limited, and/or restricted. This may reduce encoding time (e.g., improve encoder speed). For example, different MMVD sets (derived by shifting, pruning, or re-ordering of the original MMVD set) may be switched at block level or slice/picture level. A (e.g., full) merge candidate list may be used to determine a (e.g., the best) base predictor to start with. A motion vector predictor index may be signaled to indicate the (e.g., best) MVP. A merge candidate list per block may be reordered to have a better (e.g., the best) base predictor at or among the first few (e.g., two) positions.

Motion characteristics of a block may be used (e.g., in the techniques described herein) to improve MMVD performance (e.g., for an MMVD scheme). Motion characteristics of a block may be derived, for example, using one or more of the following features: (i) an average size of motion vector predictors in the merge candidate list (MVPₐvg); (ii) a motion activity index (MI) of a current block derived using a motion map (e.g., from a game engine); and/or (iii) a distance of a current block (d) from a camera derived using a depth map (e.g., from a game engine).

Blocks having objects with larger motion may employ MMVD with integer distances (e.g., compared to blocks having objects with small motion). Employing integer distances for blocks having objects with larger motion may be utilized as described by examples provided herein.

An MMVD distance table may be determined. MMVD may be implemented by searching for a (e.g., the best) refinement candidate at P*A positions, for example, with respect to a given base motion vector predictor, where P may be a number of distances and A may be a number of angles (e.g., or direction). The features described herein (e.g., above) may be used to determine an MMVD distance table, which may be referred to, for example, as a modified MMVD distance table. An MMVD distance table may include, for example, one or more of the following: a reduced MMVD distance table with k candidates, where k<P; a re-ordered MMVD distance table with k; P; an MMVD distance table shifted by shift factor s; and/or a new MMVD set.

A large average size of motion vector predictors (MVPₐvg) may reflect an area with large motion, which may indicate favorable conditions to use integer distances. A smaller MVP_{avg} may indicate conditions to use fractional distances. A motion activity index (MI) of a given block obtained from a corresponding block inside an input motion map may be determined, for example, in accordance with Equations (1), (2) and (3):

$${MV}_{{avg}_{x}} = \frac{1}{{N}_{B}} {\sum }_{( m , n ) ∈ B} {MV}_{x} ( m , n ) \qquad ( 1 )$$

$${MV}_{{avg}_{y}} = \frac{1}{{N}_{B}} {\sum }_{( m , n ) ∈ B} {MV}_{y} ( m , n ) \qquad ( 2 )$$

$$MI = \frac{1}{{N}_{B}} ( \vert {MV}_{{avg}_{x}} \vert + \vert {MV}_{{avg}_{y}} \vert ) \qquad ( 3 )$$

where, MV_{arg}_{ₓ} may be an average motion vector in the x direction per block and MV_{avg}_{_{y}} may be an average motion vector in the y direction per block. A motion activity index (MI) of a given block may be used to decide between fractional and integer distances. In addition to or alternatively to employing an average of the MVPs, other values derived from the MVPs may be employed in deriving a motion activity index and subsequently a depth motion activity index. For example, a variance in the values of the MVPs or the size of one or more, e.g., the base, of the MVPs may be determined and used to determine a motion activity index and/or depth motion activity index.

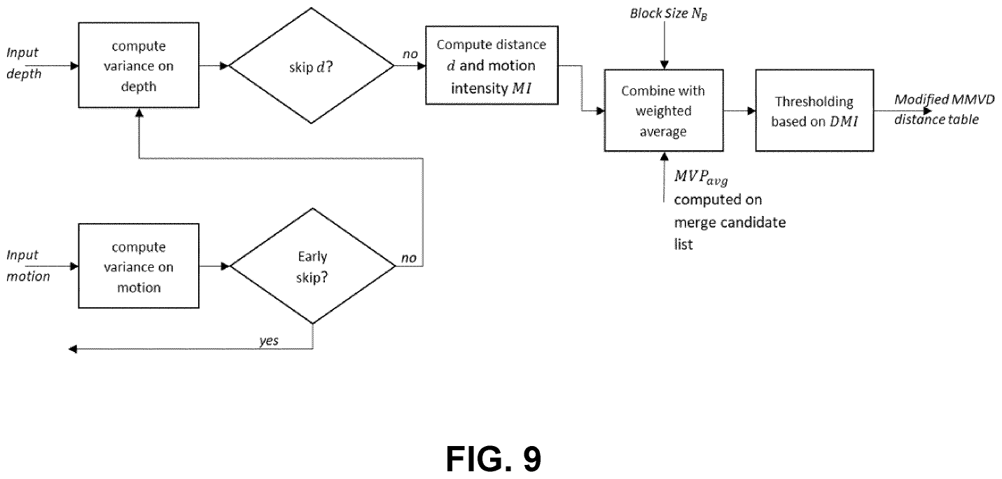

A distance d of a current block may be useful where blocks closer to a camera have larger motion compared to blocks further from a camera. A distance d of a current block may be used to derive an optimal set of MMVD distances. A distance d of a current block may be computed for example, in accordance with Equation (4):

$$d = \frac{1}{{2}^{bd} * {N}_{B}} {\sum }_{( m , n ) ∈ B} D ( m , n ) \qquad ( 4 )$$

where bd may be bit-depth, N_{B} may be the size of a block B, and D(m, n) may be the depth value at position (m, n) inside a block B. FIG. 9 shows an example of the method to determine an MMVD distance table.

FIG. 9 illustrates an example of determining a MMVD distance table based on input depth, motion, MVPs, and block size, each of which may be referred to as, for example, information associated with a current block. As shown in FIG. 9, variance of the motion map corresponding to the current block may be computed (e.g., first), for example, to determine whether (e.g., verify if) motion inside a block is uniform or not. An early termination may be performed, for example, if motion inside a block is not uniform. An early termination may indicate that MMVD mode is not considered and/or that a conventional RD search is performed.

A variation of the depth map corresponding to a current block may be computed to determine whether (e.g., verify if) an edge is present or not. The distance d may be ignored in a determination of an optimal set of MMVD distances, for example, if an edge is present.

A depth motion activity index (DMI) may be derived, for example, in accordance with Equation (5) by weighted averaging of different features described above.

$$DMI = α * d + β * MI + γ * {MVP}_{avg} \qquad ( 5 )$$

where, α, β, γ and δ may be weights assigned to each (e.g., respective) feature. Weights may be (e.g., empirically) derived from (e.g., a large set of) training data. A weight for a feature may be set to zero, for example, if/when the feature is not available or is not used.

DMI may be compared to a set of thresholds to obtain an MMVD distance table set. The thresholds may be (e.g., empirically) calculated from (e.g., a large set of) training data. For example, DMI may be compared to a given threshold T. If DMI<T, then the MMVD distance table may be modified as follows: Modified MMVD Distance table D1={¼, ½, 1}-pel. If DMI>T, then the MMVD distance table may be modified as follows: Modified MMVD Distance table D1={2, 4, 8, 16, 32}-pel. In an embodiment, two or more distance tables may be available for use as the modified MMVD distance table. If DMI<T, the device may determine to use a first of the two or more distance tables. If DMI>T, the device may determine to use a second of the two or more distance tables.

An MMVD direction table may be determined. Features (e.g., as described herein) may be useful for determining (e.g., preferred) MMVD distances and/or for (e.g., consecutively) deriving the distance table. In some examples, one or more features may be unsuitable for determining (e.g., preferred) MMVD directions among a set of directions.

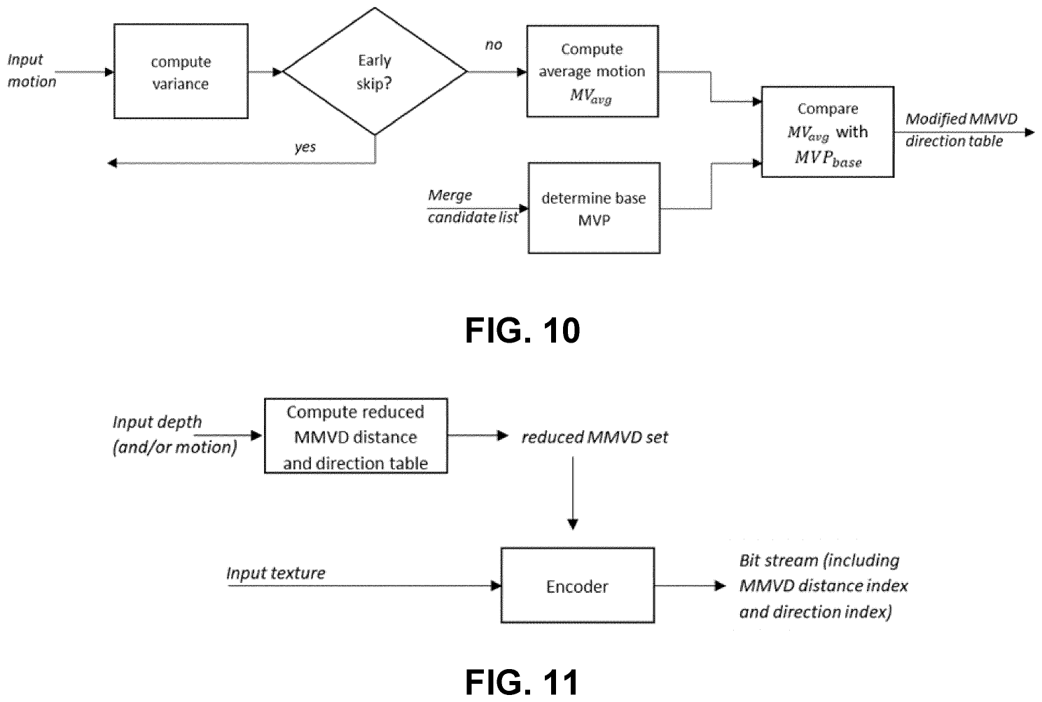

An MMVD direction table may be determined, for example, by comparing the base MV (MVP_{base}) with the average motion MVₐvg of a given block obtained from the motion map. FIG. 10 illustrates an example of determining an MMVD direction table.

FIG. 10 illustrates an example of determining a MMVD direction table based on a motion map. Motion inside a block may be determined to be uniform or not, for example, using a variance-based method (e.g., as described herein). An early termination may be performed for blocks with non-uniform motion (e.g., with high variance). An average motion of a block may be computed in x-direction (MV_{avg}_{ₓ}) and y-direction (MV_{avg}_{_{y}}) (e.g., using Equations (1) and (2), respectively), for example, if motion is uniform. Average MV may be compared with the selected MVP (MVP_{base}) in x and y directions, for example, to determine an MMVD direction table, which may be referred to as, for example, a modified MMVD direction table.

A right MMVD direction search may be more probable than a left MMVD direction search, for example, if/when the average motion of a block is greater than the predictor in the x-direction. Conversely, a right MMVD direction search may be more probable. A similar determination may be used in the y-direction to decide between top and bottom direction search.

In some examples, an encoder may be accelerated using input depth or motion information. Methods (e.g., as described herein) may be used to reduce the number of positions to be tested in MMVD mode. For example, the modified MMVD distance tables and the modified MMVD direction tables prepared as described herein may result in a reduction of the number of positions to be tested in MMVD mode during refinement of a merge candidate motion vector. A reduction in the number of positions to be tested in MMVD mode may (e.g., further) reduce the RD search of the encoder, which may reduce the (e.g., overall) encoding time. FIG. 11 shows an example of reducing the number of positions to be tested in MMVD mode. FIG. 11 illustrates an example of employing depth or motion information for encoder acceleration.

In some examples, signaling may be reduced using a reduced MMVD set. A signaling reduction may be normative (e.g., applied to the encoder and decoder). Methods (e.g., as described herein) may be used to deduce the reduced MMVD set. The depth or motion map may be available to the encoder and decoder. A (e.g., the same) process may be performed at the encoder and decoder to find an (e.g., the best) MMVD set for a given block based, for example, on the available depth information, motion information, MVPs, or their combinations. A reduced MMVD set may be a pruned MMVD set which may or may not test (e.g., test all) refinements. For example, in WC, a MMVD distance table may comprise 8 distances. A pruned MMVD set may be obtained based on a threshold value. If a calculated DMI (e.g., equation 5) may be less than a given threshold T1, an original MMVD distance table may be pruned as follows: {¼, ½, 1, 2, 4, 8, 16, 32}-pel+{¼, ½, 1, 2}-pel.

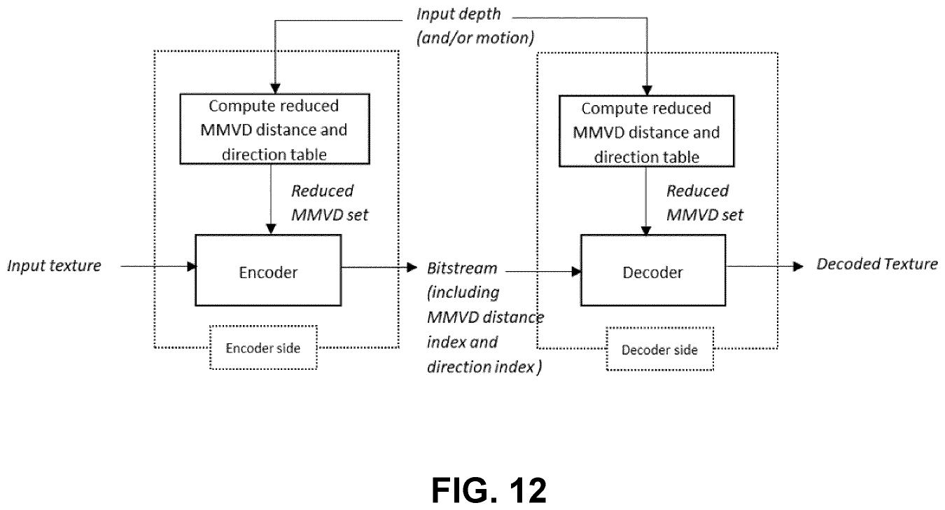

FIG. 12 depicts an example of reducing signaling using a reduced MMVD set at the encoder side and the decoder side based on input depth and/or motion information. A reduced MMVD set may be (e.g., adaptively) determined on the encoder side and the decoder side. An MMVD distance index and/or direction index may be (e.g., explicitly) signaled and determined, for example, using a search process. An encoder may operate faster with a reduced set. Reducing signaling using a reduced MMVD set may lead to coding gains, e.g., since fewer bits may be used to signal, e.g., send, the reduced MMVD index. One bit may be saved per CU block (e.g., as only a flag may be coded), for example, if/when a direction table is reduced to 2 directions.

In some examples, signaling may be reduced by using (e.g., adaptive) re-ordering of an MMVD set. An (e.g., adaptive) re-ordered MMVD distance and direction table may be obtained per block. An (e.g., adaptive) re-ordered MMVD distance and direction table per block may lead to cost savings, for example, by coding the most probable distance and direction with fewer bits. A (e.g., adaptive) re-ordered MMVD distance and direction table per block may be implemented without other signaling changes. For example, if DMI (e.g., equation 5) may be greater than a given threshold T2, the MMVD distance table may be reordered as follows: {¼, ½, 1, 2, 4, 8, 16, 32}-pel+{2, 4, 8, ¼, ½, 1, 16, 32}-pel.

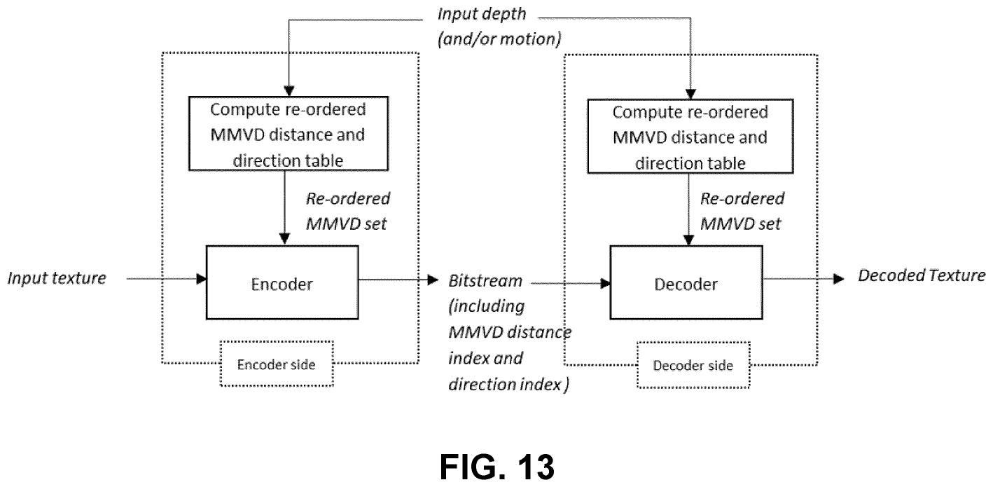

FIG. 13 illustrates an example of re-ordered MMVD set derivation (e.g., at the encoder side and the decoder side) based on a depth map and/or a motion map. A direction index may be coded by a truncated unary code, for example, if/when using a re-ordered direction table. A signaling change (e.g., compared to an (original) MMVD method) may be utilized for the direction index. In some examples, a direction index may be fixed length coded. A truncated unary code may be used for binarizing the direction index. Table 4 shows an example of signaling (e.g., with the number of angles A=4).

TABLE 4
Example of signaling for a direction table
using a truncated unary code

| Direction IDX | 0 | 1 | 2 | 3 |
|---|---|---|---|---|
| Signaling | 0 | 10 | 110 | 111 |

The signaling may provide cost savings, for example, if/when a direction table is re-ordered as described herein (e.g., determining an MMVD direction table).

Signaling may be reduced using a (e.g., an adaptively) shifted MMVD set. An implementation (e.g., as described herein, such as determining an MMVD distance table) may be used to compute a (e.g., an optimal) shift factor s at a (e.g., each) CU block. A shift factor of four (4) may be applied to an MMVD distance table, for example, if/when a flag (e.g., ph_mmvd_fullpel_only_flag) is enabled. A shift factor may be applied to use integer distances for MMVD refinement, for example, if/when use of fractional distances to code screen content is not suitable. In some implementations of MMVD, a shift factor s may be applied to an MMVD distance table, for example, if/when a flag (e.g., ph_mmvd_fullpel_only_flag) is enabled. A shift factor may be applied to sequences with screen content, for example, if fractional distances are unsuitable.

Different shift factors s may be enabled and/or used at a CU level. A shift factor may be determined using some or all features described herein (e.g., to determine an MMVD distance table). Motion and depth information (e.g., if used for determining the shift factor s) may be available on the encoder side and the decoder side.

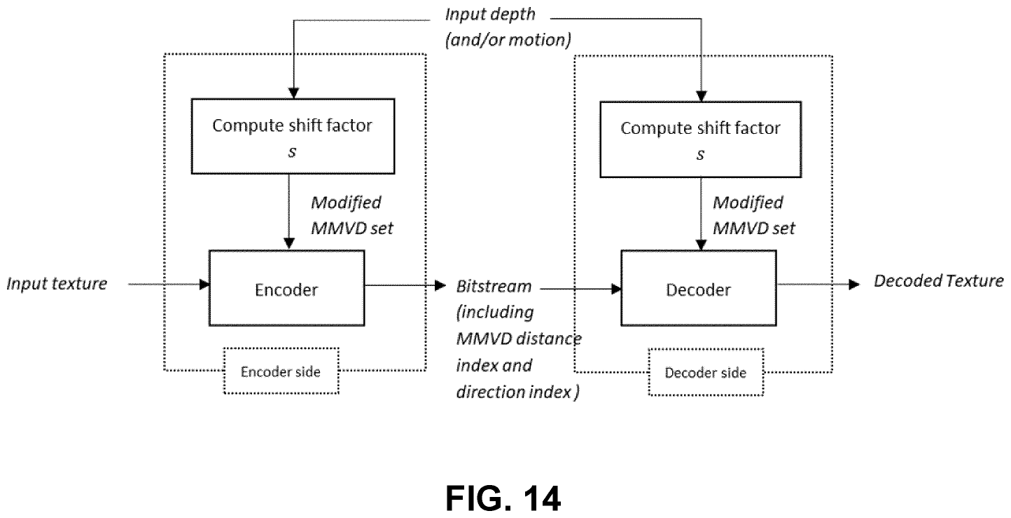

FIG. 14 illustrates an example of shifting an MMVD set based on depth and/or motion information. For example, an MMVD distance set may be determined after applying a shift factor s on the encoder side and the decoder side. The MMVD distance index may be signaled. Compression may be achieved, for example, by applying a different set of distances for blocks with different characteristics. A distance index may be truncated unary coded. Coding benefits may be achieved, for example, if/when most probable distances are placed at or near the top of (e.g., first in) the table.

Signaling may be reduced using a replacement (e.g., new) MMVD set. A MMVD distance table, e.g., new MMVD distance table, may be used (e.g., instead of deriving an MMVD distance table using a shift factor). A MMVD distance table, e.g., new MMVD distance table, may be determined, for example, as described herein.

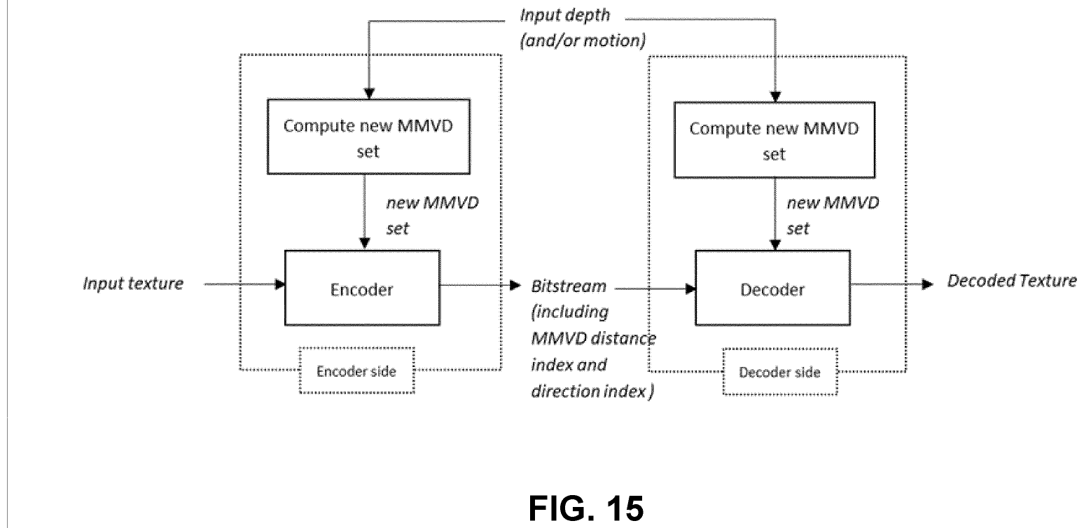

A distance table set {¼, ½, 1, 2, 3, 4, 5, 6} may be used for small motion (e.g., derived from features described herein). A distance table set {1, 2, 4, 8, 12, 16, 20, 24, 28} may be applied at medium motion. A distance table set {32, 40, 48, 56, 64, 72, 80, 88} may be applied for larger motion. FIG. 15 illustrates an example of a method for determining a MMVD set, e.g., new MMVD set.

FIG. 15 illustrates an example determining a replacement (e.g., new) MMVD set based on depth and/or motion information. In some examples, an MMVD set may be signaled at slice/picture level (e.g., for a changed or replaced MMVD set). An MMVD set may be signaled at a slice level. An MMVD set may be signaled, for example, by one or more of the following: (i) signaling a shift factor s at a slice level, where decoder may decode the shift value from the bitstream for a (e.g., each) slice and apply the shift value to the MMVD distance table within the slice; and/or (ii) signaling an index at a slice level to point to an MMVD distance table inside a dictionary of MMVD distance sets. Table 5 and Table 6 provide examples of the syntax for the two examples, respectively.

TABLE 5
Example of syntax to signal an MMVD shift factor at a slice level

| | |
|---|---|
| if( sh_slice_type != I ) { | |
| ... | |
| if( sps_mmvd_enabled_flag && !ph_mmvd_fullpel_only_flag) | |
| sh_mmvd_shift_factor | u(n) |
| ... | |
| } | |

TABLE 6
Example of syntax to signal an MMVD distance table index at a slice level

| | |
|---|---|
| if( sh_slice_type != I ) { | |
| ... | |
| if( sps_mmvd_enabled_flag && !ph_mmvd_fullpel_only_flag) | |
| sh_mmvd_distance_table_idc | u(n) |
| ... | |
| } | |

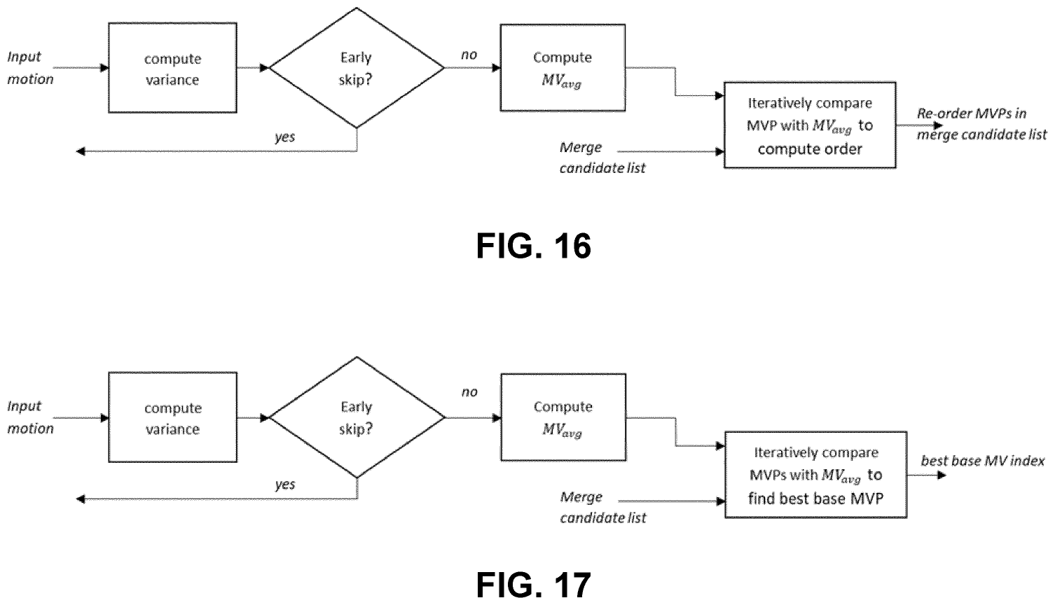

Signaling may be reduced using adaptive re-ordering of a merge candidate list. In some implementations of MMVD, some (e.g., the first two) predictors from the merge candidate list may be refined, which may be sub-optimal. A template matching based merge candidate list re-ordering scheme may be implemented. Motion information deduced from the motion map may be used to determine a changed (e.g., or re-ordered) merge candidate list for a given block. Average motion MV_{avg} may be computed from a motion map corresponding to a current block. The computed average motion MV_{avg} may be compared to the predictors in the merge candidate list. The predictors may be re-ordered, for example, in an order of decreasing similarity. A template matching based merge candidate list re-ordering method may assume that a motion map is available on the encoder side and the decoder side. FIG. 16 depicts an example of template matching based merge candidate list re-ordering.

FIG. 16 illustrates an example of adaptively re-ordering MVPs in merge candidates (e.g., if/when motion data is available on the encoder side and the decoder side).

A base MV predictor (e.g., the best base MV predictor) may be determined. In some examples (e.g., as shown in FIG. 16), a motion map may be available on the encoder side and the decoder side. In some examples (e.g., if/when a motion map may be available only on the encoder side), an (e.g., the best) MV predictor MVP_{base} may be determined by (e.g., iteratively) comparing the MV_{avg}_{_{y}} with one or more (e.g., all) of the MVPs in the merge list. The merge candidate flag may be replaced by a merge candidate index. The decoder side may construct a merge candidate list (e.g., as usual). The merge candidate index may be decoded to indicate the base MV used on the encoder side. FIG. 17 illustrates an example of determining a base MV predictor, for example, if/when a motion map may be available only on the encoder side.

FIG. 17 illustrates an example of determining a merge candidate index to indicate an (e.g., the best) MV to be used as a base MV for MMVD refinement.

Systems, methods, and instrumentalities have been disclosed for generating a modified motion information table. A video encoding/decoding device may modify a motion information refinement table (e.g., a MMVD distance table and/or MMVD direction table) based on information associated with a current block. For example, the video encoding/decoding device may modify the motion information refinement table based on one or more of Motion Vector Predictors (MVP), motion information (e.g., motion map), or depth information (e.g., depth map). The video encoding/decoding device may refine a merge candidate motion vector (MV) of the current block based on the modified motion information refinement table. The video encoding/decoding device may encode or decode the current block based on the refined merge candidate MV.

Systems, methods, and instrumentalities have been disclosed for performing encoding and/or decoding in merged motion vector difference (MMVD) mode using depth and/or motion information. MMVD tables (e.g., MMVD distance and/or direction sets) may be adaptively (e.g., dynamically) generated (e.g., customized) for blocks based on input motion and/or input depth information. MMVD distance and/or direction sets may accelerate coding, reduce signaling, and/or improve compression. Depth and/or motion information may be used, for example, to restrict a search for MMVD candidates, change (e.g., reduce, reorder, shift, replace) MMVD distance and/or direction tables, select and/or signal a shift factor for a shifted MMVD set or an index for a replaced MMVD set, and/or to reorder a merge candidate list. MMVD distance and/or direction sets may be determined from motion characteristics, such as depth maps, motion maps, and/or motion vector predictors (MVPs) (e.g., base MVP, average size of MVPs), average motion of a block, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-94. (canceled)

95. A device for video decoding comprising:
a processor configured to:
modify a motion information refinement table based on at least Motion Vector Predictors (MVP) associated with a current block;
modify a merge candidate motion vector of the current block based on the modified motion information refinement table; and
decode the current block based on the modified merge candidate MV.

96. The device of claim 95,
wherein the processor configured to modify the motion information refinement table based on at least MVP associated with the current block is further configured to modify the motion information refinement table based on at least MVP associated with the current block and motion information comprising a motion map associated with the current block.

97. The device of claim 95,
wherein the processor configured to modify the motion information refinement table based on at least MVP associated with the current block is further configured to modify the motion information refinement table based on at least MVP associated with the current block and depth information comprising a depth map associated with the current block.

98. The device of claim 95,
wherein the processor configured to modify the motion information refinement table based on at least MVP associated with the current block is further configured to modify the motion information refinement table based on at least MVP associated with the current block, motion information comprising a motion map associated with the current block, and depth information comprising a depth map associated with the current block.

99. The device of claim 95,
wherein the motion information refinement table is one of a merged motion vector difference (MMVD) distance table or a MMVD direction table.

100. The device of claim 95,
wherein the processor configured to modify the motion information refinement table based on at least MVP associated with the current block is configured to re-order the motion information refinement table.

101. A method of video decoding comprising:
modifying a motion information refinement table based on at least Motion Vector Predictors (MVP) associated with a current block;
modifying a merge candidate motion vector (MV) of the current block based on the modified motion information refinement table; and
decoding the current block based on the modified merge candidate MV.

102. The method of claim 101,
wherein modifying the motion information refinement table based on at least MVP associated with the current block further comprises modifying the motion information refinement table based on at least MVP associated with the current block and motion information comprising a motion map associated with the current block.

103. The method of claim 101,
wherein modifying the motion information refinement table based on at least MVP associated with the current block further comprises modifying the motion information refinement table based on at least MVP associated with the current block and depth information comprising a depth map associated with the current block.

104. The method of claim 101,
wherein modifying the motion information refinement table based on at least MVP associated with the current block further comprises modifying the motion information refinement table based on at least MVP associated with the current block, motion information comprising a motion map associated with the current block, and depth information comprising a depth map associated with the current block.

105. The method of claim 101,
wherein the motion information refinement table is one of a merged motion vector difference (MMVD) distance table or a MMVD direction table.

106. The method of claim 101,
wherein modifying the motion information refinement table based on at least MVP associated with the current block further comprises re-ordering entries in the motion information refinement table.

107. A device for video encoding comprising:
a processor configured to:
modify a motion information refinement table based on at least Motion Vector Predictors (MVP) associated with a current block;
modify a merge candidate motion vector (MV) of the current block based on the modified motion information refinement table; and
decode the current block based on the modified merge candidate MV.

108. The device of claim 107,
wherein the processor configured to modify the motion information refinement table based on at least MVP associated with the current block is further configured to modify the motion information refinement table based on at least MVP associated with the current block and motion information comprising a motion map associated with the current block.

109. The device of claim 107,
wherein the processor configured to modify the motion information refinement table based on at least MVP associated with the current block is further configured to modify the motion information refinement table based on at least MVP associated with the current block and depth information comprising a depth map associated with the current block.

110. The device of claim 107,
wherein the processor configured to modify the motion information refinement table based on at least MVP associated with the current block is further configured to modify the motion information refinement table based on at least MVP associated with the current block, motion information comprising a motion map associated with the current block, and depth information comprising a depth map associated with the current block.

111. A method of video decoding comprising:
modifying a motion information refinement table based on at least Motion Vector Predictors (MVP) associated with a current block;
modifying a merge candidate motion vector (MV) of the current block based on the modified motion information refinement table; and
decoding the current block based on the modified merge candidate MV.

112. The method of claim 111,
wherein modifying the motion information refinement table based on at least MVP associated with the current block further comprises modifying the motion information refinement table based on at least MVP associated with the current block and motion information comprising a motion map associated with the current block.

113. The method of claim 111,
wherein modifying the motion information refinement table based on at least MVP associated with the current block further comprises modifying the motion information refinement table based on at least MVP associated with the current block and depth information comprising a depth map associated with the current block.

114. The method of claim 111,
wherein modifying the motion information refinement table based on at least MVP associated with the current block further comprises modifying the motion information refinement table based on at least MVP associated with the current block, motion information comprising a motion map associated with the current block, and depth information comprising a depth map associated with the current block.
